(19) United States
(12) Patent Application Publication
(10) Pub. No.: US 2026/0281695 A1
(43) Pub. Date: Sep. 17, 2026

(54) MANAGING SUBSCRIBER IDENTITY MODULE MEMORY RESET DURING USER ACTIVITY

(71) Applicant: GOOGLE LLC, Mountain View, CA (US)

(72) Inventors: Edison Chen, Taipei (TW); Aakash Phoughat, New Taipei City (TW)

(21) Appl. No.: 19/162,381

(22) PCT Filed: Mar. 30, 2023
(86) PCT No.: PCT/US2023/016883

§ 371 Date: Sep. 4, 2025

(51) Int. Cl. H04W 8/18

(52) U.S. Cl. CPC H04W 8/183

(57) ABSTRACT

A user equipment (UE) device in a mobile cellular network implements one or more techniques to manage subscriber identity module (SIM) memory reset events. For example, the UE device sends a SIM memory reset request to at least one SIM. In response to sending the SIM memory request to the SIM, the UE device receives a SIM update command from the SIM for a SIM memory reset event. The UE device, in response to receiving the first SIM update command, generates a refresh command for updating information associated with the SIM. Responsive to detecting current user activity associated with the first SIM, the UE device queues the generated first refresh command until one or more conditions are satisfied. Responsive to detecting no current user activity associated with the first SIM, the UE device processes, without queueing, the generated first refresh command.

### BACKGROUND

A user equipment (UE) device often communicates through cellular data networks that operate within an administratively licensed band, such that only licensed cellular network operators are permitted to establish data networks (each a “primary cellular data network”) within the licensed band. The licensed operators are allocated respective spectra within the licensed band which prevents unlicensed operators from utilizing the licensed bands.

To connect with a primary cellular data network, the UE device utilizes a subscription profile that is administered by an associated mobile network operator.

The subscription profile generally includes an international mobile subscriber identity (IMSI) number and its related key. The subscription profile is typically stored on the subscriber identity module (SIM) of the UE device and provides the UE device with network access information for access to the associated primary cellular data network. A subscription profile may allow the user UE to connect to multiple associated primary cellular data network nodes such that the UE device can communicate with the associated primary cellular data network within a wide geographic area.

### SUMMARY OF EMBODIMENTS

In accordance with one aspect, a method at a cellular user equipment (UE) device for managing subscriber identity module (SIM) memory reset events includes receiving, from a first SIM, a first SIM update command for a SIM memory reset event responsive to sending a SIM memory reset request to the first SIM. Responsive to receiving the first SIM update command, a first refresh command is generated for updating information associated with the first SIM. Responsive to detecting current user activity associated with the first SIM, the generated first refresh command is queued until one or more conditions are satisfied.

In at least some embodiments, the SIM update command is a SIM platform reset command.

In at least some embodiments, responsive to the one or more conditions having been satisfied, the generated first refresh command is processed.

In at least some embodiments, responsive to detecting no current user activity associated with the first SIM, the generated first refresh command is processed without being queued.

In at least some embodiments, a determination is made that a second SIM is enabled, and the SIM memory reset request is sent to the second SIM.

In at least some embodiments, responsive to sending the SIM memory reset request to the second SIM, a second SIM update command is received from the second SIM for a SIM refresh event. Responsive to receiving the second SIM update command, a second refresh command is generated for updating information associated with the second SIM. Responsive to detecting current user activity associated with the second SIM, the generated second refresh command is queued until one or more conditions are satisfied.

In at least some embodiments, responsive to the one or more conditions having been satisfied, the generated second refresh command is processed.

In at least some embodiments, responsive to detecting no current user activity associated with the second SIM, the generated second refresh command is processed without being queued.

In accordance with another aspect, a method at a cellular user equipment (UE) device for managing subscriber identity module (SIM) memory reset events includes receiving, from a first SIM, a first SIM update command for a SIM memory reset event responsive to sending a SIM memory reset request to the first SIM.

Responsive to detecting current user activity associated with the first SIM, the first SIM update command is queued until one or more conditions are satisfied or the first SIM update command is rejected.

In at least some embodiments, the first SIM update command is a SIM refresh command.

In at least some embodiments, responsive to queueing the current user activity, a timer is initiated. Responsive to initiating the timer, a determination is made whether the one or more conditions have been satisfied. Responsive to the one condition having been satisfied, the first SIM update command is processed.

In at least some embodiments, at least one of the one or more conditions is the current user activity completing prior to the timer expiring.

In at least some embodiments, responsive to queueing the current user activity, a timer is initiated. Responsive to initiating the timer, a determination is made whether at least one condition of the one or more conditions has been satisfied. Responsive to at least one condition of the one or more conditions having been satisfied, the first SIM update command is rejected.

In at least some embodiments, responsive to no current user activity associated with the first SIM, the first SIM update command is processed without being queued.

In at least some embodiments, responsive to rejecting the first SIM update command, the UE device waits for the first SIM to reissue the first SIM update command.

In at least some embodiments, a determination is made that a second SIM is enabled. The SIM memory reset request is sent to the second SIM.

In at least some embodiments, responsive to sending the SIM memory reset request to the second SIM, a second SIM update command is received from the second SIM. Responsive to detecting current user activity associated with the second SIM, the second SIM update command is queued until one or more conditions are satisfied.

In at least some embodiments, responsive to the one or more conditions having been satisfied, the second SIM update command is processed.

In at least some embodiments, a user equipment device is configured to implement any of the methods described above and herein.

In at least some embodiments, a non-transitory computer-readable medium storing executable instructions configured to manipulate a processor of a user equipment device to implement any of the methods described above and herein

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a diagram illustrating an example wireless communication system employing a user equipment (UE) device implementing one or more mechanisms for managing subscriber identity module (SIM) memory reset events in accordance with some embodiments.

FIG. 2 is a block diagram illustrating example modes of a SIM memory reset handling/managing mechanism employed by the UE device of FIG. 1 in accordance with some embodiments.

FIG. 3 is a diagram illustrating an example configuration of a UE device implementing one or more mechanisms for managing SIM memory reset events in accordance with some embodiments.

FIG. 4 illustrates a diagram of an example operation of implementing one or more techniques for managing SIM memory reset events at a UE device in accordance with some embodiments.

FIG. 5 illustrates a diagram of another example operation of implementing one or more techniques for managing SIM memory reset events at a UE device in accordance with some embodiments.

### DETAILED DESCRIPTION

A wireless communication device (also referred to herein as a user equipment (UE) device) typically includes a subscriber identity module (SIM), such as a physical SIM card, virtual SIM, or an embedded SIM (eSIM), that stores information relating to a subscriber identity associated with the UE device. For example, one type of a SIM is a universal integrated circuit card (UICC) or an embedded UICC (eUICC) that stores information, such as authentication information, authorization information, identification information, and the like, for accessing different network services. A UICC typically includes a single mobile network operator (MNO) profile whereas an eUICC is able to host multiple MNO profiles.

In some instances, the UE device receives or detects a SIM memory reset event. For example, a user of the UE device can select a menu option for performing a SIM memory reset, such as a SIM factory reset. In another example, an MNO, a subscriber manager, or another entity can send a command or notification to the UE device triggering the SIM memory reset. When the UE device receives or detects the SIM memory reset event, the SIM performs one or more memory reset operations.

For example, the SIM is returned to a state prior to being provisioned, one or more of the profiles on the SIM are deleted, one or more of the profiles on the SIM are deactivated, a combination thereof, or the like. Depending on the configuration of the UE device, the UE device handles the SIM memory reset in different ways. For example, in a configuration where the UE device operates in a Single Enabled Profile (SEP) mode, the SIM typically generates and sends a SIM update command or notification to the UE device after the SIM memory reset has been completed so that the UE device can process the SIM memory reset. Examples of the SIM update command or notification include a refresh command or a platform reset command.

The UE device can either process the SIM update or reject the SIM update.

However, if the UE device processes the SIM update while user activity is in progress at the UE device, the user activity will likely be dropped, resulting in, for example, performance issues and a poor user experience. Therefore, because a SIM update can interfere with various user activities at the UE device, the MNO generally stipulates that the UE device is to reject (i.e., not perform) a SIM update while user activity is in progress at the UE device. However, rejecting the SIM update during user activity is problematic because the SIM is typically not required to retry the update procedure, resulting in a failure of the UE device to update the information it maintains about the SIM.

In a configuration where the UE device operates in a Multiple Enabled Profiles (MEP) mode, one SIM can be enabled or multiple SIMs can be enabled. In either scenario, the UE device typically sends the SIM memory reset request to a first SIM associated with the communication/modem stack. If the first SIM is enabled, the first SIM performs the SIM memory reset and sends a SIM update to the UE device. The UE device then processes or rejects the SIM update depending on its configuration set by the MNO. However, as described above with respect to the SEP mode, issues arise when the UE device processes the SIM update while user activity is in progress at the UE device or if the UE device rejects the SIM update. If the first SIM (e.g., SIM in first logical position of the communication stack) is not enabled but a second SIM (e.g., SIM in a subsequent logical position of the communication stack) is enabled, the UE device typically sends the SIM memory reset request only to the first SIM. In this scenario, the UE device does not receive a SIM update from either SIM because the first SIM does not have any enabled profiles and the second SIM did not receive the SIM memory reset request. Therefore, incorrect SIM information will be displayed to the user. For example, a non-reset state of the second SIM will be shown even a SIM memory reset request was issued. If both the first SIM and the second SIM are enabled, the UE device similarly sends the SIM memory reset request only to the first SIM. In this scenario, the first SIM processes the SIM memory reset and sends a SIM update command to the UE device, which proceeds as described above. However, because the SIM memory reset request is not sent to the second SIM in this scenario, the second SIM does not perform the SIM memory reset request nor does the second SIM send a SIM update command to the UE device. Therefore, incorrect SIM information will be displayed to the user as described above.

To prevent these and other issues involving SIM memory reset requests, a UE device, using the techniques described herein, employs a SIM memory reset handling mechanism to advantageously handle SIM memory reset events during user activity at the UE device. In at least some embodiments, when a UE device detects a SIM memory reset event and the UE device is operating in an MEP mode, the UE device determines which of the SIMs are enabled (or has occurring user activity) and sends a corresponding SIM memory reset request to each enabled SIM. For example, in addition to sending the SIM memory reset request to the first SIM (e.g., SIM at Logical Secure Element Interface (LSI) 0) in the communication stack independent of whether the first SIM is enabled or disabled, the UE device also sends the SIM memory reset request to any subsequent/secondary SIMs (e.g., SIM at LSI 1, SIM at LSI 2, and so on) in the communication stack that is enabled. As such, the secondary SIMs that are enabled can be properly reset unlike in conventional configurations that only send the SIM memory reset request to the first SIM. Also, in at least some embodiments, if the first SIM is not enabled, the UE device sends the SIM memory reset request directly to the secondary enabled SIMs without sending the SIM memory reset request to the first SIM.

In at least some embodiments, when a UE device detects a SIM memory reset event, the UE device determines one or more standard specifications directed to SIM memory reset events that are supported by the UE device and SIM. Different versions of the European Telecommunications Standards Institute (ETSI) Technical Specification (TS) 102 223 define different operations to be performed by the UE device and SIM when processing an event such as a SIM memory reset. For example, versions of ETSI TS 102 223 before version 17.1.0 indicate that the SIM is to issue a SIM refresh command after completing a SIM memory reset, whereas at least version 17.1.0 of ETSI TS 102 223 indicates that the SIM is to issue a SIM platform reset command after completing a SIM memory reset. The UE device, in at least some embodiments, determines the version of the indicated standard specification(s) supported by the UE device and SIM independent of whether the UE device is operating in an SEP mode or an MEP mode. In at least some embodiments, the UE device determines the version of the indicated standard specification(s) supported by the UE device and SIM based on the terminal profile of the UE device, which indicates to the SIM the SIM-related features supported by the UE device.

If the UE device is operating in an SEP mode and supports an ETSI TS 102 223 version older than 17.1.0, after the SIM has processed and completed the SIM memory reset request, the SIM is configured to issue a SIM refresh command to the UE device. The UE device identifies whether there is any user activity (or specified user activity), such as an active Emergency Call Center (ECC) call, an enabled active emergency callback mode, an active voice call, an ongoing short message service (SMS) process, active menu navigation, or the like. If there is no user activity, the UE device processes the SIM refresh command so that the UE device can update the information it maintains about the SIM. If there is user activity in progress, the UE device does not immediately process the SIM refresh command. In at least some embodiments, the UE device selectively determines whether to retry the SIM refresh command on the UE device side or the SIM side. In other embodiments, the UE device is pre-configured to retry the SIM refresh command on the UE device side or the SIM side. If the UE device selects or is configured to retry the SIM refresh command on the SIM side, the UE device sends a Terminal Response (or other message/response type) to the SIM indicating that the UE device is unable to process the SIM refresh command. The SIM then reissues the SIM refresh command at a later time (e.g., upon expiration of a timer). If the UE device selects or is configured to retry the SIM refresh command on the UE side, the UE device stores/queues (e.g., holds) the SIM refresh command and, in at least some embodiments, sends a Terminal Response (or other message/response type) to the SIM indicating that the UE device is unable to process the SIM refresh command.

The UE device initiates a timer and waits for the user activity to complete. In at least some embodiments, the UE device determines if the user activity has completed by registering a callback with a user activity module for the completion status of the user activity, polling the user activity module at given intervals of time, a combination thereof, or the like. If the user activity completes prior to the timer expiring, the UE device processes the refresh command and resets the timer. However, if the user activity does not complete before the timer expires, the UE device rejects the SIM refresh command to prevent the user activity from being dropped and waits for a SIM retry.

If the UE device is operating in an MEP mode and supports a version of ETSI TS 102 223 prior to version 17.1.0, the UE device and each enabled SIM proceed similarly to the SEP mode described above. However, before, after, or during processing of the SIM memory reset request by the first SIM, the UE device sends the SIM memory reset request to the next enabled SIM (e.g., a second SIM) in the communication stack that is enabled. In at least some embodiments, the UE device waits until the UE device has processed the SIM refresh issued from the first SIM before sending the SIM memory reset request to the second SIM. In other embodiments, the UE device sends the SIM memory reset request to the second SIM before or during processing of the SIM refresh issued by the first SIM. In at least some embodiments, if the first SIM is not enabled, the UE device sends the SIM memory reset request directly to one or more of the enabled SIMs. After the second SIM receives the SIM memory reset request, the second SIM and UE device then proceed similarly to the SEP mode described above. The UE device, in at least some embodiments, processes the SIM refresh issued from the second SIM before, after, or concurrently with the SIM refresh issued by the first SIM. A similar process is performed for each additional enabled SIM in the communication stack.

In some instances, high-priority user activity, such as an emergency call, associated with the second SIM can occur after the first SIM processes the SIM memory reset request. In this scenario, the UE device does not want to interrupt the high-priority user activity. Therefore, the UE device creates a refresh update process such that the UE device monitors for the high-priority user activity to finish at the second SIM. After the high-priority user activity has completed, the UE device forwards the SIM memory reset request to the second SIM for processing. After the second SIM has processed the SIM memory reset, the second SIM issues a SIM refresh command to the UE device as described above, which includes reading data from the SIM to update the information the UE device maintains about the SIM.

If the UE device is operating in an SEP mode and supports ETSI TS 102 223 version 17.1.0 (or greater), after the SIM has processed and completed the SIM memory reset request, the SIM is configured to issue a SIM platform reset command to the UE device. Conventionally, when the UE device receives the SIM platform reset command, the UE device either processes the SIM platform reset command, which negatively affects any user activity in progress, or rejects the SIM platform reset command, which results in UE device failing to perform a SIM update because the SIM is not configured to perform a retry for the SIM platform reset command.

However, in at least some embodiments, the UE device is configured to generate a refresh command in response to receiving the SIM platform reset command. In at least some embodiments, the refresh command initiates a voting process configured to determine when the user activity has completed and triggers the UE device to perform a SIM update process when there is no user activity. For example, as part of the UE-generated refresh command, the UE device identifies whether there is any user activity (or specified user activity) by sending a voting request to one or more user activity modules. If there is no user activity, the UE device performs a SIM refresh/update process, which includes reading data from the SIM to update the information the UE device maintains about the SIM. If there is user activity in progress, the UE device holds off on performing the SIM refresh process and stores/queues (e.g., holds) the UE-UE-generated refresh command. In at least some embodiments, the UE device initiates a timer and, upon expiration of the timer, executes the UE-generated refresh command to perform the voting process to determine if the user activity is still active. If the user activity has not completed, the refresh command is queued again and the timer is reset. However, if the voting process indicates that user activity has completed, the UE device performs a SIM refresh process, which includes reading data from the SIM to update the information the UE device maintains about the SIM.

If the UE device is operating in an MEP mode and supports ETSI TS 102 223 version 17.1.0 (or greater), the UE device and each enabled SIM proceed similarly to the SEP mode described above for ETSI TS 102 223 version 17.1.0 (or greater). However, before, after, or during processing of the SIM memory reset request by the first SIM, the UE device sends the SIM memory reset request to the next SIM (e.g., a second SIM) in the communication stack that is enabled. In at least some embodiments, the UE device waits until the UE-generated refresh command has been processed before sending the SIM memory reset request to the second SIM. In other embodiments, the UE device sends the SIM memory reset request to the second SIM before or during processing of the UE-generated refresh command. In at least some embodiments, if the first SIM is not enabled, the UE device sends the SIM memory reset request directly to one or more of the enabled SIMs, as described above.

As such, the techniques described herein manage SIM memory reset requests such that a SIM memory reset request is forwarded to each enabled SIM of the UE device and the corresponding SIM update processes performed by the UE device take into consideration user activity in progress at each enabled SIM. The techniques also configure the UE device according to the standards specification supported by the UE device and SIM. For example, if a SIM is configured to issue a SIM refresh command to the UE device, the techniques described herein queue the SIM refresh command while user activity is occurring at the UE device instead of immediately rejecting the command. In another example, if the SIM is configured to issue a SIM platform reset command to the UE device, the techniques described herein generate a refresh process that checks whether there is user activity currently in progress at any of the enabled SIMs. If user activity is currently in progress, the refresh command is queued until the user activity has completed. By forwarding a SIM memory reset request to each enabled SIM, the UE device provides an opportunity for each enabled SIM to process the memory reset request and issue a SIM update command. Also, by queuing the corresponding SIM refresh command issued by the SIM or generated by the UE device, the UE device provides an opportunity for each enabled SIM to process the user activity to complete before rejecting the SIM refresh, which helps the UE device from missing SIM updates. It should be understood that a SIM is an example used throughout this description for purposes of illustration, and the techniques described herein are not limited to a SIM but to any subscriber identity format that uses the same or similar memory reset operations.

For ease of illustration, the following techniques are described in an example context in which one or more UE devices and radio access networks (RANs) implement one or more radio access technologies (RATs), including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, it should be understood that the present disclosure is not limited to networks employing a 5G NR RAT configuration, but rather the techniques described herein can be applied to any combination of different RATs employed at the UE devices and the RANs. It should also be understood that the present disclosure is not limited to any specific network configurations or architectures described herein for implementing SIM memory reset handling at the UE device.

Instead, techniques described herein can be applied to any configuration of RANs.

Also, the present disclosure is not limited to the examples and context described herein, but rather the techniques described herein can be applied to any network environment where a UE device implements SIM memory reset handling techniques.

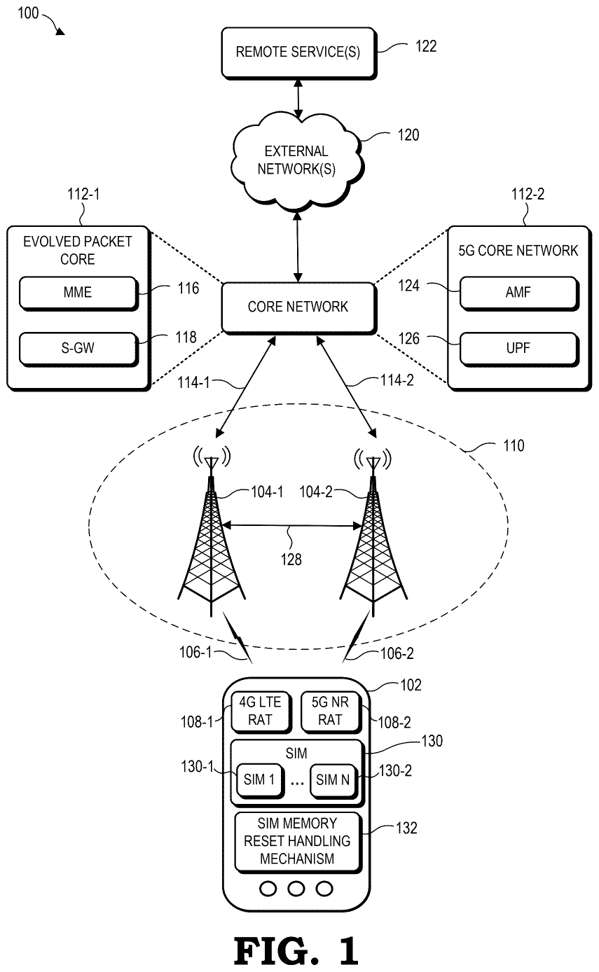

FIG. 1 illustrates a mobile cellular network (system) 100 in accordance with at least some embodiments. As shown, the mobile cellular network 100 includes a user equipment (UE) device 102 that is configured to implement the techniques described herein for handling/managing SIM memory reset events in accordance with one or more embodiments. The UE device 102 communicates with one or more base stations (BSs) 104 (BSs 104-1 and 104-2) through one or more wireless communication links 106 (wireless links 106-1 and 106-2). The UE device 102, in at least some embodiments, includes any of a variety of wireless communication devices, such as a cellular phone, a cellular-enabled tablet computer or cellular-enabled notebook computer, a cellular-enabled wearable device, an automobile, or other vehicle employing cellular services (e.g., for navigation, provision of entertainment services, in-vehicle mobile hotspots, etc.), and so on. In at least some embodiments, the UE device 102 employs a single radio access technology (RAT) 108. In other embodiments, the UE device 102 is a multi-mode UE device that employs multiple RATs 108. Examples of multiple RATs include a 3GPP Long-Term Evolution (3GPP LTE) RAT 108-1 and a 3GPP Fifth Generation New Radio (5G NR) RAT 108-2.

In at least some embodiments, the BSs 104 are implemented in a macrocell, microcell, small cell, picocell, and the like, or any combination thereof. Examples of BSs 104 include an Evolved Universal Terrestrial Radio Access Network Node B (E-UTRAN Node B), evolved node B (eNodeB or eNB), Next Generation (NG or NGEN) Node B (gNode B or gNB), and so on. The BSs 104 communicate with the UE device 102 via the wireless links 106, which are implemented using any suitable type of wireless link. The wireless links 106, in at least some embodiments, include a downlink of data and control information communicated from the BSs 104 to the UE device 102, an uplink of data and control information communicated from the UE device 102 to the BSs 104, or both. The wireless links 106 (or bearers), in at least some embodiments, are implemented using any suitable communication protocol or standard, or combination of communication protocols or standards, such as 3 4G LTE, 5G NR, and so on. In at least some embodiments, multiple wireless links 106 are aggregated in a carrier aggregation to provide a higher data rate for the UE device 102. Also, multiple wireless links 106 from multiple BSs 104 are configured, in at least some embodiments, for coordinated multipoint (COMP) communication with the UE device 102, as well as dual connectivity, such as single-RAT LTE-LTE or NR-NR dual connectivity, or multi-radio access technology (Multi-RAT) dual connectivity (MR-DC) including E-UTRA-NR dual connectivity (EN-DC), NGEN radio access network (RAN) E-UTRA-NR dual connectivity (NGEN-DC), and NR E-UTRA dual connectivity (NE-DC). In at least some embodiments, a BS 104 also includes an inter-base station interface 128, such as an Xn and/or X2 interface configured to exchange user-plane and control-plane data between another BS 104.

The BSs 104 collectively form a Radio Access Network 110, such as an E-UTRAN or 5G NR RAN. The BSs 104 are connected to a core network 112 via control-plane and user-plane interfaces through one or more links 114 (links 114-1 and 114-2). Depending on the configuration of the mobile cellular network 100, the core network 112 is either an evolved packet core (EPC) network 112-1 or a 5G core network (5GC) 112-2. For example, in an E-UTRAN configuration or a 5G non-standalone (NSA) EN-DC configuration, the core network 112 is an EPC network 112-1 that includes, for example, a mobility management entity (MME) 116 and a serving gateway (S-GW) 118. The MME 116 provides control-plane functions, such as registration and authentication of multiple UE devices 102, authorization, mobility management, and so on. The S-GW 118 relays user-plane data between UE devices 102 and external networks 120 (e.g., the Internet) and one or more remote services 122. In a 5G standalone (SA) configuration or an NSA NE-DC or NGEN-DC configuration, the core network 112 is a 5GC network 112-2. The 5GC 112-2 includes, for example, an access and mobility management function (AMF) 124 and a user plane function (UPF) 126. The AMF 124 provides control-plane functions such as registration and authentication of multiple UE devices 102, authorization, mobility management, and so on. The UPF 126 relays user-plane data between UE devices 102 and external networks 120 (e.g., the Internet) and one or more remote services 122.

In one or more embodiments, the UE device 102 includes a subscriber identity module (SIM) 130. As used herein, the terms subscriber identity module, SIM, or identity module, refer to any circuit (integrated or discrete), chip, card or smart card, and the like that includes information about the user of the UE device 102 used for authenticating the user to the network 100 providing access to subscribed services. Also, when referring to more than one SIM, the term “SIMs” refers to two or more physical SIMs, two or more embedded SIMs on a single physical SIM, two or more embedded SIMs on two or more physical SIMS, or the like. For example, the SIM 130 illustrated in FIG. 1 includes one or more embedded or physical SIMs 130-1 and 130-2, or a combination thereof. In at least some embodiments, the SIM 130 stores networking information and subscriber information for the UE device 102. The SIM 130 uniquely identifies the UE device 102 on the mobile cellular network 100 and validates the UE device's right to use the mobile cellular network 100. During operation, the UE device 102 receives or detects one or more SIM memory reset events. For example, a user of the UE device 102 can select a menu option for performing a SIM memory reset, such as a SIM factory reset. In another example, the core network 112 or another network entity sends a command or notification to the UE device 102 triggering the SIM memory reset. When the UE device 102 receives or detects the SIM memory reset event, the SIM 130 performs one or more memory reset operations. For example, the SIM 130 is returned to a state prior to being provisioned, one or more of the profiles on the SIM 130 are deleted, one or more of the profiles on the SIM 130 are deactivated, a combination thereof, or the like. After the SIM 130 has completed the SIM memory reset process, the SIM 130 generates and sends a proactive SIM update command or notification to a component of the UE device 102, such as a processor (e.g., an application processor, a communication processor, a combination thereof, or the like). The SIM update command notifies the UE component that the content or structure of files (e.g., elementary files) on the SIM 130 have changed, and instructs the UE component to refresh information that it maintains about the SIM 130.

In many instances, the UE device receives a SIM update command from the SIM when user activity associated with one or more enabled SIMs is occurring at the UE device. Examples of user activity include an active emergency call center (ECC) call, an enabled active emergency callback mode, an active voice call, an ongoing SMS process, active menu navigation, or the like. In a typical configuration, a UE device rejects the SIM update command when user activity is occurring at the UE device or processes the SIM update command. However, in a scenario where the UE device rejects the SIM update command, the SIM is not required to reissue the SIM update command. In these instances, the UE device typically does not process the SIM update command nor does the UE device update its corresponding SIM information. In a scenario where the UE device processes the SIM update command, the UE device will often drop the current user activity. For example, the UE device drops the active voice call or SMS messaging process, which results in poor performance and user experience. Also, depending on the version of the standards specification directed to SIM memory resets, such as ETSI TS 102 223, supported by the UE device and SIM, the SIM issues a different SIM update command. For example, for versions of ETSI TS 102 223 before version 17.1.0, a SIM is configured to issue a SIM refresh command. However, for at least version 17.1.0 of ETSI TS 102 223, a SIM is configured to issue a SIM platform reset command. The UE device typically performs a different process to handle these different SIM update commands. Moreover, when multiple SIMs are enabled, a UE device is typically configured to only send the SIM memory reset request to the SIM in the first logical position of the communication stack, which may not even be enabled. Any SIM logically situated after the first SIM does not receive the SIM memory reset request, which usually results in incorrect SIM information being maintained by the UE device.

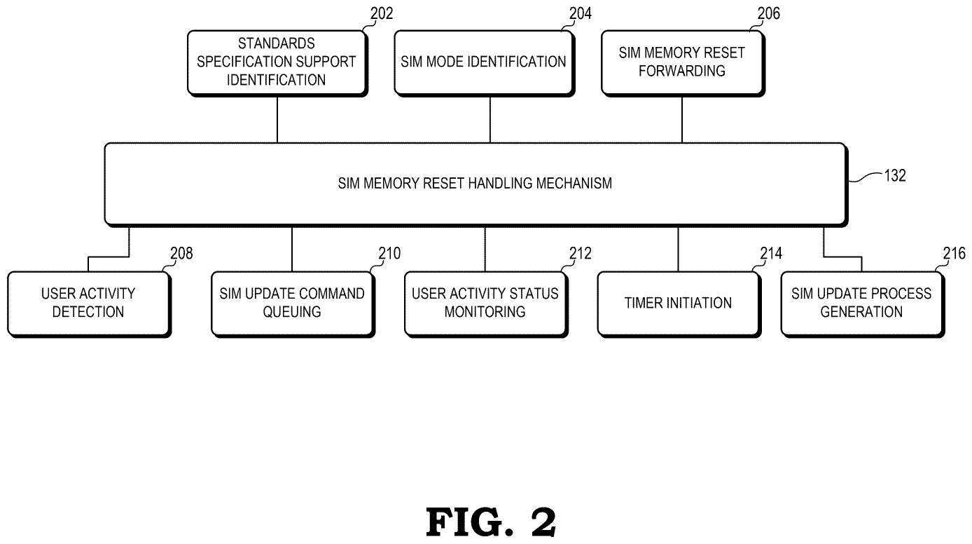

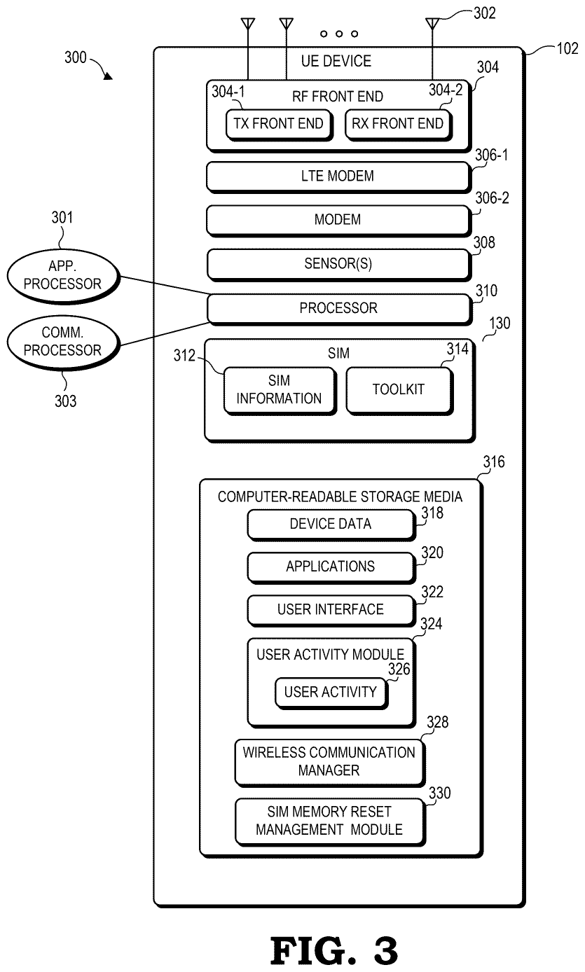

Accordingly, in at least some embodiments, the UE device 102 employs one or more SIM memory reset handling mechanisms 132 to advantageously manage SIM memory reset events when user activity associated with one or more SIMs 130 is occurring at the UE device 102. In at least some embodiments, the SIM memory reset handling mechanism(s) 132 employs different processes for handling SIM memory resets depending on the standard specification(s) supported by the UE device 102 and SIM 130, whether the UE device 102 is operating in an SEP mode or an MEP mode, or the like. As described in greater detail below, the SIM refresh handling mechanism(s) 132 includes one or more modes to facilitate the SIM memory reset handling techniques described herein. For example, when the UE device 102 is operating in an MEP mode, the UE device 102 forwards a SIM memory reset request to each enabled SIM 130 instead of forwarding the request only to the SIM 130 in the first logical position of the communication stack. Also, after a SIM 130 completes a SIM memory reset and issues a SIM update command to the UE device 102, the UE device queues the SIM update command (or UE-generated refresh command) instead of immediately processing or rejecting the command. By queuing the SIM refresh command (or UE-generated refresh command), the UE device 102 provides an opportunity for the user activity to complete before processing or rejecting the command, which helps prevent the user activity from being dropped and avoid failure of the UE device to update its corresponding SIM information. Also, the UE device 102 is configured to perform different SIM memory reset handling techniques depending on the version(s) of the standard specifications directed to SIM memory resets that is supported by the UE device 102 and SIM 130. As such, the UE device 102 is configured such that SIM memory resets are properly handled regardless of the standard specifications supported by the UE device 102 and SIM 130 FIG. 2 illustrates various example modes (e.g., mode 202 to mode 216) employed singularly or in various combinations by the UE device 102 as part of the SIM memory reset handling mechanism 132 in accordance with some embodiments. Each of these modes is discussed in greater detail below with respect to FIG. 3 to FIG. 5. One such mode includes a first SIM memory reset handling mode 202. In this mode, the SIM memory reset handling mechanism 132 determines the version of an indicated standards specification, such as ETSI TS 102 223 or any other specification relating to SIM memory reset events, supported by the UE device 102 and SIM 130. For example, the SIM memory reset handling mechanism 132 determines if the UE device 102 and the SIM 130 support version 17.1.0 (or above) of the ETSI TS 102 223 or a previous version. Depending on the version of the indicated standards specification supported by the UE device 102 and the SIM 130, the SIM memory reset handling mechanism 132 is configured to employ one or more different processes with respect to the SIM update command issued by the SIM 130, as described in greater detail below. In at least some embodiments, the first SIM memory reset handling mode 202 is not employed. In these embodiments, the SIM memory reset handling mechanism 132 is pre-configured to perform one or more of the techniques described herein based on the version of the indicated standards specification supported by the UE device 102 and the SIM 130.

In a second SIM memory reset handling mode 204, the SIM memory reset handling mechanism 132 identifies the SIM mode currently being employed by the UE device 102. For example, the SIM memory reset handling mechanism 132 determines if the UE device 102 is operating in an SEP mode or an MEP mode. If the UE device 102 is operating in an MEP mode, a third SIM memory reset handling mode 206 forwards a SIM memory reset request to each enabled SIM 130 in the communication stack. In at least some embodiments, the SIM memory reset request is sent to a first SIM 130-1 (i.e., a SIM in the first logical SIM position of the communication stack) regardless of whether the first SIM 130-1 is enabled or not enabled. Then, the SIM memory reset request is sent to a second SIM 130-2 (e.g., a SIM in a subsequent logical position of the communication stack) that is enabled. If any additional SIMs 130 are enabled, the SIM memory reset request is also sent to these SIMs 130 as well. The SIM memory reset request, in at least some embodiments, is sent to the first SIM 130-1, the second SIM 130-2, and any other SIM sequentially or in parallel.

When a SIM 130 processes the SIM memory request, the SIM 130 issues a SIM update (proactive) command to the UE device 102. For example, in one configuration, the SIM 130 issues a proactive SIM platform reset command as defined in ETSI TS 102 223 v17.1.0. In another configuration, the SIM 130 issues a proactive SIM refresh command as defined in versions of ETSI TS 102 223 before v17.1.0. The SIM platform reset command is able to reset the whole card session (e.g., multiple LSI sessions), whereas the SIM refresh command can only reset a single LSI session. As such, the SIM platform reset command is applicable to MEP and SEP configurations, whereas the SIM refresh command is applicable to only an SEP configuration. It should be understood that the techniques described herein are also applicable to other types of SIM update command capable of being issued by a SIM 130. As such, in at least some embodiments, the SIM memory reset handling mechanism 132 is configured to handle multiple different types of SIM update commands. For example, a SIM refresh command typically triggers the UE device 102 to perform a SIM update process, whereas a SIM platform reset command does not. Therefore, if the SIM 130 is configured to issue a platform reset command compared to, for example, a SIM refresh command, a fourth SIM memory reset handling mode 208 generates a refresh command (also referred to herein as a “UE-generated refresh command”). As described below, the UE-generated refresh command initiates a voting process that triggers the UE device 102 to perform a SIM update process or to requeue the UE-generated refresh command.

In a fifth SIM memory reset handling mode 210, the SIM memory reset handling mechanism 132 monitors for user activity associated with a SIM 130 that issued the SIM update command before the UE device 102 processes (or rejects) the SIM update command or performs a SIM update process triggered by the UE-generated refresh command. In response to determining that no user activity (or no specified user activity) associated with the issuing SIM 130 is occurring at the UE device 102, the SIM memory reset handling mechanism 132 instructs one or more components of the UE device 102 to process the SIM update command or the SIM update process associated with the UE-generated refresh command. If user activity associated with the issuing SIM 130 is occurring, the SIM memory reset handling mechanism 132 does not immediately process the SIM update process associated with the UE-generated refresh command. For example, in a first configuration, the SIM memory reset handling mechanism 132 is configured to initiate a retry for the SIM update command at the SIM side. In a second configuration, the SIM memory reset handling mechanism 132 is configured to initiate a retry for the SIM update command or queues the UE-generated refresh command at the UE device side.

As such, when implementing the first configuration, the SIM memory reset handling mechanism 132 rejects the SIM update command. If the SIM 130 is configured to retry the SIM update command, the SIM memory reset handling mechanism 132 waits for the SIM 130 to reissue the SIM update command. When implementing the second configuration, a sixth SIM refresh handling mode 212 of SIM memory reset handling mechanism 132 queues the SIM update command or the UE-generated refresh command. A seventh SIM refresh handling mode 214 then initiates a timer, and an eighth SIM refresh handling mode 216 monitors the status of the user activity. For example, during execution of the timer, a determination is made whether the user activity has completed. If the user activity completes prior to the timer expiring, the SIM memory reset handling mechanism 132 instructs one or more components of the UE device 102 to process the queued SIM update command and resets the timer. However, if the user activity does not complete before the timer expires and a SIM update command was queued, the SIM refresh handling mechanism 132 (or another component) rejects the SIM update command to prevent the user activity from being dropped and waits for a SIM refresh retry by the SIM 130. If a UE-generated refresh command was queued, upon expiration of the timer, the refresh command is executed to initiate a voting process with one or more user activity modules 324 (FIG. 3) to determine if the user activity has completed. If the user activity is still active, the SIM refresh handling mechanism 132 (or another component) resets the timer and requeues UE-generated refresh command. If the voting process indicates that the user activity has completed, the UE device 102 performs a SIM update process.

FIG. 3 illustrates an example device diagram 300 of a UE device 102. In at least some embodiments, the device diagram 300 describes a UE device that implements the SIM memory reset handling techniques described herein. The UE device 102 may include additional functions and interfaces that are omitted from FIG. 3 for the sake of clarity. The UE device 102, in at least some embodiments, includes antennas 302, a radio frequency (RF) front end 304, and one or more RF transceivers 306 (e.g., a 3 4G LTE transceiver 306-1 and a 5G NR transceiver 306-2) for communicating with one or more base stations 104 in a RAN 110, such as a 5G RAN, an E-UTRAN, a combination thereof, and so on. The RF front end 304, in at least some embodiments, includes a transmitting (Tx) front end 304-1 and a receiving (Rx) front end 304-2. The Tx front end 304-1 includes components such as one or more power amplifiers (PA), drivers, mixers, filters, and so on. The Rx front end 304-2 includes components such as low-noise amplifiers (LNAs), mixers, filters, and so on. The RF front end 304, in at least some embodiments, couples or connects the one or more transceivers 306, such as the LTE transceiver 306-1 and the 5G NR transceiver 306-2, to the antennas 302 to facilitate various types of wireless communication.

In at least some embodiments, the antennas 302 of the UE device 102 include an array of multiple antennas configured similarly to or different from each other. The antennas 302 and the RF front end 304, in at least some embodiments, are tuned to or are tunable to one or more frequency bands, such as those defined by the 3GPP LTE, 3GPP 5G NR, IEEE wireless local area network (WLAN), IEEE wireless metropolitan area network (WMAN), or other communication standards. In at least some embodiments, the antennas 302, the RF front end 304, the LTE transceiver 306-1, and the 5G NR transceiver 306-2 are configured to support beamforming (e.g., analog, digital, or hybrid) or in-phase and quadrature (I/Q) operations (e.g., I/Q modulation or demodulation operations) for the transmission and reception of communications with one or more base stations 104. By way of example, the antennas 302 and the RF front end 304 operate in sub-gigahertz bands, sub-6 Gigahertz (GHz) bands, above 6 GHz bands, or a combination of these bands defined by the 3GPP LTE, 3GPP 5G NR, or other communication standards.

In at least some embodiments, the antennas 302 include one or more receiving antennas positioned in a one-dimensional shape (e.g., a line) or a two-dimensional shape (e.g., a triangle, a rectangle, or an L-shape) for embodiments that include three or more receiving antenna elements. While the one-dimensional shape enables the measurement of one angular dimension (e.g., an azimuth or an elevation), the two-dimensional shape enables two angular dimensions to be measured (e.g., both azimuth and elevation). Using at least a portion of the antennas 302, the UE device 102 can form beams that are steered or un-steered, wide or narrow, or shaped (e.g., as a hemisphere, cube, fan, cone, or cylinder). The one or more transmitting antennas may have an un-steered omnidirectional radiation pattern or may produce a wide steerable beam. Either of these techniques enables the UE device 102 to transmit a radio signal to illuminate a large volume of space. In some embodiments, the receiving antennas generate thousands of narrow steered beams (e.g., 2000 beams, 4000 beams, or 6000 beams) with digital beamforming to achieve desired levels of angular accuracy and angular resolution.

The UE device 102, in at least some embodiments, includes one or more sensors 308 implemented to detect various properties such as one or more of temperature, supplied power, power usage, battery state, or the like. Examples of sensors include a thermal sensor, a battery sensor, a power usage sensor, and so on. The UE device 102 also includes at least one processor 310. The processor 310, in at least some embodiments, is a single-core processor or a multiple-core processor composed of a variety of materials, such as silicon, polysilicon, high-K dielectric, copper, and so on. In at least some embodiments, the processor 310 is implemented at least partially in hardware including, for example, components of an integrated circuit or a system-on-a-chip (SoC), a digital-signal-processor (DSP), an application-specific integrated circuit (ASIC), a field-programmable gate array (FPGA), a complex programmable logic device (CPLD), other embodiments in silicon or other hardware, or a combination thereof.

Examples of the processor(s) 310 include an application processor 301, a communication processor 303, microprocessors, DSPs, controllers, and so on. A communication processor, in at least some embodiments, is implemented as a modem baseband processor, software-defined radio module, configurable modem (e.g., multi-mode, multi-band modem), wireless data interface, wireless modem, or so on. In at least some embodiments, a communication processor supports one or more of data access, messaging, or data-based services of a wireless network, as well as various audio-based communication (e.g., voice calls). An application processor, in at least some embodiments, provides computing resources to applications executing on the UE device 102. For example, an application provides a self-contained operating environment that delivers system capabilities (e.g., graphics processing, memory management, and multimedia processing) to support applications executing on the UE device 102.

The UE device 102 further includes one or more SIMs 130. The SIM 130, in at least some embodiments, is a physical SIM or an embedded SIM (eSIM). One example of the SIM 130 includes a universal integrated circuit card (UICC) that can store one or more eSIMs (e.g., SIM 130-1 and SIM 130-2) for accessing different MNOs. The SIM 130 uniquely identifies the UE device 102 on the mobile cellular network 100 and validates the UE device's right to use the mobile cellular network 100. In at least some embodiments, the SIM 130 comprises one or more of SIM information 312, an application toolkit 314, and the like. It should be understood that the SIM 130 can include additional components not shown in FIG. 3. The SIM information 312, in at least some embodiments, comprises information such as an IMSI number and its related key, authentication information, authorization information, identification information, and the like, for accessing different network services. The application toolkit 314, in at least some embodiments, is a set of commands or applications that are programmed into the SIM 130 that define how the SIM 130 is to interact with an environment (e.g., the mobile cellular network 100) outside of the UE device 102.

The UE device 102 further includes a non-transitory computer-readable storage media 316 (CRM 316). The computer-readable storage media described herein excludes propagating signals. The CRM 316, in at least some embodiments, includes any suitable memory or storage device such as random-access memory (RAM), static RAM (SRAM), dynamic RAM (DRAM), non-volatile RAM (NVRAM), read-only memory (ROM), or Flash memory useable to store device data 318 of the UE device 102. In at least some embodiments, the device data 318 includes user data, multimedia data, beamforming codebooks, applications 320, a user interface(s) 322, one or more user activity modules 324, an operating system of the UE device 102, and so on, which are executable by the processor(s) 310 to enable user-plane communication, control-plane signaling, and user interaction with the UE device 102. Alternatively, or additionally, the operating system of the UE device 102 is maintained as firmware or an application on the CRM 316 and executed by the processor(s) 310. In at least some embodiments, the user interface 322 includes a graphical user interface (GUI) that receives the input information via a touch input. In other instances, the user interface 322 includes an intelligent assistant that receives the input information via an audible input or speech. The user activity module(s) 324 monitors/handles user activity occurring at the UE device 102 and stores an indication or information 326 associated with the occurring user activity. For example, the user activity module 324 stores an indication that one or more of an active ECC call, an enabled active emergency callback mode, an active voice call, an ongoing SMS process, active menu navigation, or the like is currently occurring at the UE device 102. Alternatively, or additionally, the user activity module 324 is implemented in the processor 310, the SIM 130, or both. In at least some embodiments, the user activity module 324 is comprised of multiple user activity modules that each monitor/handle a specified type of user activity. For example, the user activity module 324 comprises an ECC activity module, a voice call activity module, and an SMS activity module, and the like.

In at least some embodiments, the CRM 316 also includes either or both of a communication manager 328 and a SIM memory reset management module 330.

Alternatively, or additionally, either or both of the communication manager 328 and the SIM memory reset management module 330, in at least some embodiments, are implemented in whole or part as hardware logic or circuitry integrated with or separate from other components of the UE device 102. For example, in at least some embodiments, one or more of the communication manager 328 or the SIM memory reset management module 330 are implemented as part of a processor(s) 310, such as an application processor, a communication processor, a combination thereof, or the like. Alternatively, or additionally, either or both of the communication manager 328 and the SIM memory reset management module 330 are distributed across one or more components of the UE device 102. In at least some embodiments, the communication manager 328 configures the RF front end 304, the LTE transceiver (modem) 306-1, the 5G NR transceiver (modem) 306-2, or a combination thereof, to perform one or more wireless communication operations.

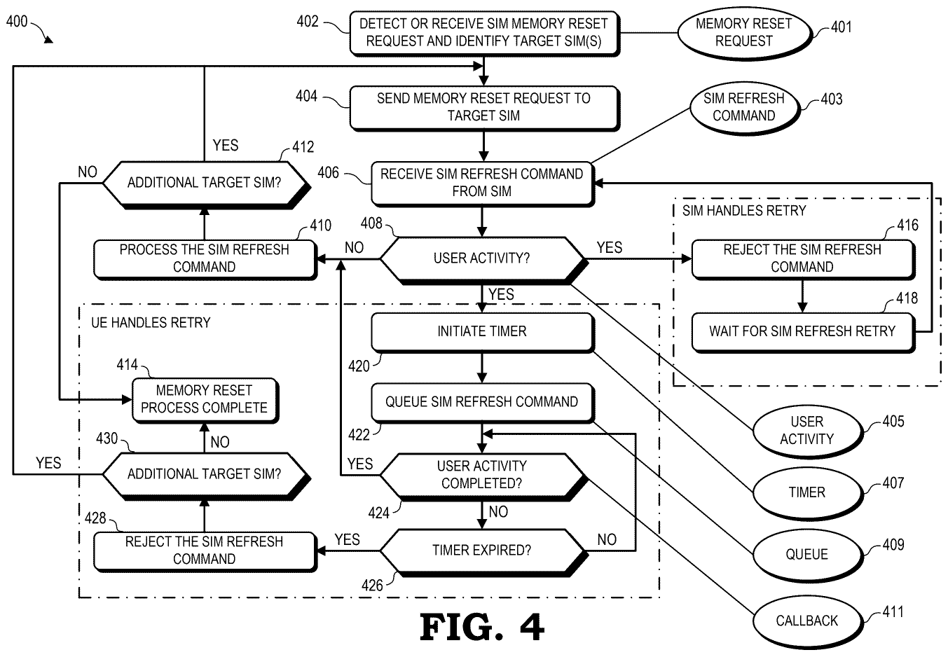

The SIM memory reset management module 330, in at least some embodiments, implements the SIM memory reset handling mechanism(s) 132 for advantageously handling SIM memory reset events when user activity is occurring at the UE device 102, as described in greater detail below with respect to FIG. 4.

FIG. 4 illustrates, in flow chart form, one example method 400 of the SIM memory reset management module 330 (or another component) of the UE device 102 managing SIM memory reset events. The method 400 is described, for purposes of description, with respect to an example implementation at the UE device 102 of FIG. 3, but it will be appreciated that, in other embodiments, the method 400 is implemented at UE devices 102 having different configurations. Also, the method 400 is not limited to the sequence of operations shown in FIG. 4, as at least some of the operations can be performed in parallel or in a different sequence. Moreover, in at least some embodiments, the method 400 can include one or more different operations than those shown in FIG. 4.

In this example, the SIM(s) 130 supports a version of an indicated standards specification, such as a version prior to v17.1.0 of ETSI TS 102 223, directed to a SIM memory reset process that implements a SIM refresh command (or equivalent). In at least some embodiments, the SIM memory reset management module 330 determines the version of the indicated standard specification(s) supported by the UE device and SIM based on the terminal profile of the UE device, which indicates to the SIM the SIM-related features supported by the UE device. At block 402, the SIM memory reset management module 330 detects or receives a SIM memory refresh request 401. For example, an application processor 301 issues a SIM memory refresh request 401 to the communication processor 303 (or other component) implementing the SIM memory reset management module 330. In one example, the SIM memory refresh request 401 is issued or generated in response to an event, such as a user of the UE device 102 selecting a menu option for performing a SIM memory reset, such as a SIM factory reset. In another example, an MNO, a subscriber manager, or another entity can send a command or notification to the UE device 102 triggering the SIM memory reset.

At block 404, the SIM memory reset management module 330 sends the SIM memory refresh request 401 to a target SIM 130. For example, in an SEP (or equivalent) mode, the target SIM 130 is a single SIM 130 being implemented by the UE device 102. As such, in an SEP (or equivalent) mode, the SIM memory reset management module 330 sends the SIM memory refresh request 401 to the single enabled SIM 130. In an MEP mode, the SIM memory reset management module 330 identifies all the enabled SIMs 130 (or SIMs associated with user activity that is in progress), such as one or more of a first SIM 130-1 or a second SIM 130-2. It should be understood that in the MEP (or equivalent) mode, more than two SIMs 140 can be enabled. As such, in the MEP (or equivalent) mode, the SIM memory reset management module 330 sends the SIM memory reset request 401 to each of the identified enabled SIMs 130. In at least some embodiments, the SIM memory refresh request 401 is sent to each enabled SIM 130 in parallel. In other embodiments, the SIM memory refresh request 401 is sent to each enabled SIM 130 sequentially as shown in FIG. 4. The SIM memory reset management module 330, in at least some embodiments, sends the SIM memory reset request 401 to a SIM 130-1 in the first logical position in the communication stack regardless of whether this SIM 130 is enabled or not enabled. In other embodiments, if the SIM 130 in the first logical position in the communication stack is not enabled, the SIM memory reset management module 330 sends the SIM memory reset request 401 directly to a subsequent SIM 130 (e.g., SIM 130-2) in the communication stack that is enabled.

At block 406, the SIM memory reset management module 330 receives (or detects) a SIM refresh command 403 (or equivalent command) from the SIM 130. In at least some embodiments, the SIM 130 issues the SIM refresh command 403 in response processing the SIM memory reset request 401. The SIM refresh command 403 notifies the UE device 102 that an update has occurred at the SIM 130 so that the UE device 102 can re-read the SIM 130 to update its corresponding SIM information.

At block 408, the SIM memory reset management module 330 determines if there is any user activity 405 (or specified user activity) active (e.g., occurring) at the UE device 102 that is associated with the SIM 130 that issued the SIM refresh command 403. For example, the SIM memory reset management module 330 determines if there is an active ECC call, an enabled active emergency callback mode, an active voice call, an ongoing SMS process, active menu navigation, or the like occurring at the UE device 102. In at least some embodiments, the SIM memory reset management module 330 communicates with the user activity module 324 of the UE device 102, which maintains user activity information 326 identifying any current user activity 405 occurring at the UE device 102. For example, the SIM memory reset management module 330 (or another component of the UE device 102) sends a voting request to the one or more user activity modules 324. If the user activity module(s) 324 determines that user activity 405 is occurring at the UE device 102 for the issuing SIM 130, the user activity module(s) 324 returns a vote response to the SIM memory reset management module 330 indicating that the user activity 405 is occurring. The SIM memory reset management module 330 collects all vote responses to determine if there is any current user activity 405 at the UE device 102 for the issuing SIM 130.

If the user activity 405 is inactive (e.g., not currently occurring) at the UE device 102 for the issuing SIM 130, the method 400 proceeds to block 410, and the SIM memory reset management module 330 processes the SIM refresh command 403 or instructs one or more components of the UE device 102 to process the SIM refresh command 403. If the UE device 102 is operating in an MEP mode, the SIM memory reset management module 330, at block 412, determines if there is another target SIM 130. For example, the SIM memory reset management module 330 determines if any of there are any remaining target SIMs 130 identified in block 404 that have yet to receive the SIM memory reset request 401. In another example, the SIM memory reset management module 330 determines there are any newly identified target SIMs 130, such as a SIM 130 that has become enabled or associated with active user activity after initially identifying the target SIM(s) at block 404. If there are no other target SIMs 130 to receive the SIM memory reset request 401, the SIM memory reset process is complete at block 414. If there is another target SIM 130, the method 400 returns to block 404 and the SIM memory reset management module 330 sends the SIM memory reset request 401 to the next target SIM 130. The SIM memory reset management module 330 receives a second SIM refresh command 403 from the second SIM 130-2 and the method 400 proceeds as described above. In embodiments where the SIM memory reset request 401 is sent to multiple target SIMs 130 in parallel, the decision at block 412 is not performed.

If user activity 405 is active at the UE device 102 for the issuing SIM 130, the method 400 takes one of multiple paths depending on whether the SIM memory reset management module 330 is configured to wait for the SIM 130 to retry the SIM refresh command 403 or if the SIM memory reset management module 330 retries the SIM refresh command 403 itself. If the SIM memory reset management module 330 is configured to wait for the SIM 130 to retry the SIM refresh command 403, the method 400 proceeds to block 416 and the SIM memory reset management module 330 rejects the SIM refresh command 403. For example, the SIM memory reset management module 330 sends a Terminal Response (or other message/response type) to the SIM 130 indicating that the UE device 102 is unable to process the SIM refresh command 403. At block 418, the SIM memory reset management module 330, in at least some embodiments, then waits for the SIM 130 to reissue (retry) the SIM refresh command 403. If the SIM memory reset management module 330 is configured to retry the SIM refresh command 403 itself, the method 400 proceeds to block 420 and the SIM memory reset management module 330 initiates a timer 407. At block 422, the SIM memory reset management module 330 queues the SIM refresh command 403. For example, the SIM memory reset management module 330 places the SIM refresh command 403 in a queue 409, such as a buffer or other temporary holding structure. In at least some embodiments, the SIM memory reset management module 330 queues the SIM refresh command 403 until one or more conditions are satisfied, such as the user activity 405 completing prior to the timer 407, the timer 407 expiring, or the like.

At block 424, the SIM memory reset management module 330 determines if the user activity 405 for the issuing SIM 130 has completed. In at least some embodiments, the SIM memory reset management module 330 determines if the user activity 405 has completed by registering a callback 411 with the user activity module 324 for the completion status of the user activity 405. Alternatively, or additionally, the SIM memory reset management module 330 polls the user activity module 324 at given intervals of time to determine the completion status of the user activity 405 or performs the voting process described above with respect to block 408. However, other techniques for determining or obtaining the completion status of the user activity 405 are applicable as well. If the user activity 405 for the issuing SIM 130 has completed prior to the timer 407 expiring, the method 400 proceeds to block 410, and the SIM memory reset management module 330 processes the SIM refresh command 403 or instructs one or more components of the UE device 102 to process the SIM refresh command 403. As described above, if the UE device 102 is operating in an MEP mode, the SIM memory reset management module 330, at block 412, determines if there is another target SIM 130. If there are no other target SIMs 130 to receive the SIM memory reset refresh command 403, the SIM memory reset process is complete at block 414. If there is another target SIM 14, the method 400 returns to block 404 and the SIM memory reset management module 330 sends the SIM memory reset request 401 to the next target SIM 130, such as the second SIM 130-2. The SIM memory reset management module 330 receives a second SIM refresh command 403 from the second SIM 130-2 and the method 400 proceeds as described above.

At block 426, if the user activity 405 for the issuing SIM 130 has not completed, the SIM memory reset management module 330 determines if the timer 407 has expired. If the timer 407 has not expired, the SIM memory reset management module 330 continues to monitor the completion status of the user activity 405. If the timer 407 has expired, the method proceeds to block 428, and the SIM memory reset management module 330 rejects the SIM refresh command 403. For example, the SIM memory reset management module 330 sends a Terminal Response (or other message/response type) to the SIM 130 indicating that the UE device 102 is unable to process the SIM refresh command 403. In at least some embodiments, the SIM memory reset management module 330 then waits for the SIM 130 to reissue the SIM refresh command 403.

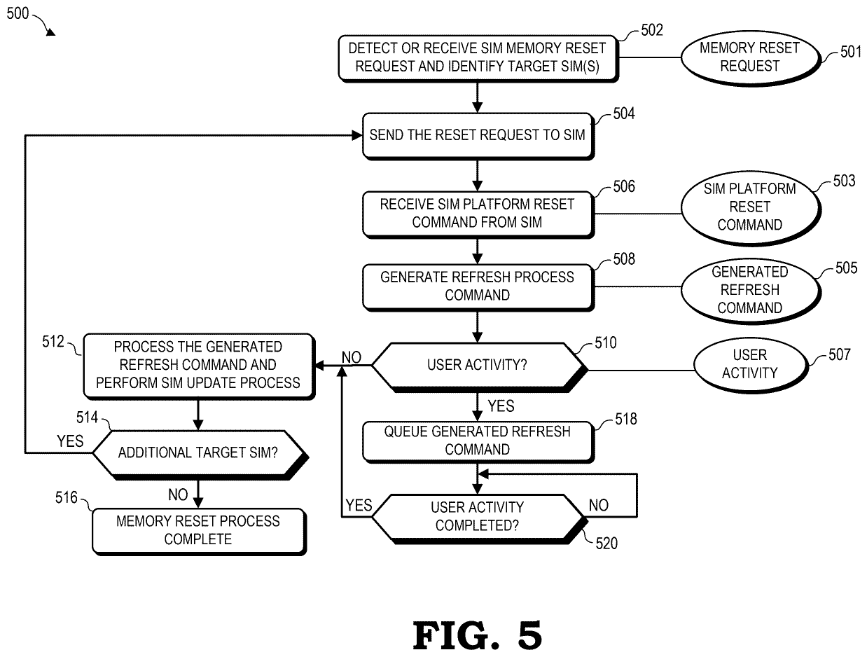

FIG. 5 illustrates, in flow chart form, another example method 500 of the SIM memory reset management module 330 (or another component) of the UE device 102 managing SIM memory reset events. The method 500 is described, for purposes of description, with respect to an example implementation at the UE device 102 of FIG. 3, but it will be appreciated that, in other embodiments, the method 500 is implemented at UE devices 102 having different configurations. Also, the method 500 is not limited to the sequence of operations shown in FIG. 5, as at least some of the operations can be performed in parallel or in a different sequence. Moreover, in at least some embodiments, the method 500 can include one or more different operations than those shown in FIG. 5.

In this example, the SIM(s) 130 supports a version of an indicated standards specification, such as version 17.1.0 or newer of ETSI TS 102 223, directed to a SIM memory reset process that implements a SIM platform reset command (or equivalent). In at least some embodiments, the SIM memory reset management module 330 determines the version of the indicated standard specification(s) supported by the UE device and SIM based on the terminal profile of the UE device, which indicates to the SIM the SIM-related features supported by the UE device. At block 502, the SIM memory reset management module 330 detects or receives a SIM memory refresh request 501 as described above with respect to block 402 of FIG. 4. At block 504, the SIM memory reset management module 330 sends the SIM memory refresh request 501 to a target SIM 130, as described above with respect to block 404 of FIG. 4.

At block 506, the SIM memory reset management module 330 receives (or detects) a SIM platform reset command 503 from the SIM 130. In at least some embodiments, the SIM 130 issues the SIM platform reset command 503 (or equivalent command) in response to processing the SIM memory reset request 501. The SIM platform reset command 503 triggers the SIM memory reset management module 330 to perform an application session termination procedure on each LSI for every active application. At block 508, the SIM memory reset management module 330 generates a refresh command 505 (also referred to herein as UE-generated refresh command 505) in response to receiving the SIM platform reset command 503 from the SIM 130. The UE-generated refresh command 505 triggers the SIM memory reset management module 330 or another component of the UE device 102 (e.g., application processor 301, communication processor 303, or the like) to perform a SIM update process so that the UE device 102 can re-read the SIM 130 to update its corresponding SIM information. For example, as part of the UE-generated refresh command 505, a voting process is performed with one or more of the user activity modules 324 to determine if user activity 507 is occurring at the UE device 102. If the voting process indicates that there is no user activity 507 currently in progress at the UE device 102, the UE-generated refresh command 505 triggers the SIM update process so that the UE device 102 to perform a SIM update process.

At block 510, in response to the UE-generated refresh command 505, the SIM memory reset management module 330 (or another component of the UE device 102) determines if there is any user activity 507 (or specified user activity) active (e.g., occurring) at the UE device 102 associated with the SIM 130 that issued the SIM platform reset command 503, as described above with respect to block 408 of FIG. 4. For example, the UE-generated refresh command 505 initiates a voting process by sending a voting request to the one or more user activity modules 324. If the user activity module(s) 324 determines that user activity 507 is occurring at the UE device 102 for the issuing SIM 130, the user activity module(s) 324 returns a vote response to the SIM memory reset management module 330 indicating that the user activity 507 is occurring. The SIM memory reset management module 330 collects all vote responses to determine if there is any current user activity 507 at the UE device 102 for the issuing SIM 130.

At block 512, if the user activity 507 is inactive (e.g., not currently occurring) at the UE device 102 for the issuing SIM 130, the SIM memory reset management module 330 performs a SIM update process or instructs one or more components of the UE device 102 to perform a SIM update process. If the UE device 102 is operating in an MEP mode, the SIM memory reset management module 330, at block 514, determines if there is another target SIM 130, as described above with respect to block 412 of FIG. 4. If there are no other target SIMs 130 to receive the SIM memory reset refresh request, the SIM memory reset process is complete at block 516. If there is another target SIM 130, the method 500 returns to block 504 and the SIM memory reset management module 330 sends the SIM memory reset request 501 to the next target SIM 130. The SIM memory reset management module 330 receives a second SIM platform reset command 503 from the second SIM 130-2 and the SIM memory reset management module 330 generates a second refresh command 505. The method 500 proceeds as described above. In embodiments where the SIM memory reset request 501 is sent to multiple target SIMs 130 in parallel, the decision at block 514 is not performed.

At block 518, if user activity 507 is active at the UE device 102 for the issuing SIM 130, the SIM memory reset management module 330 queues the UE-generated refresh command 505 in a manner similar to that described above with respect to block 422 of FIG. 4. At block 520, the SIM memory reset management module 330 determines if the user activity 507 for the issuing SIM 130 has completed, as described above with respect to block 424 of FIG. 4. In at least some embodiments implementing a timer when user activity is in progress, the length of the timer is set according to one or more configurations. For example, in a first configuration, if the user activity has a high priority, the timer is unlimited and does not expire to guarantee that the user activity completes so that a SIM update process is performed. In another configuration, the timer length is selectively or dynamically set based on the user activity. For example, a timer associated with higher-priority user activity, such as an emergency call or messaging session, is configured with a longer expiration time than a timer associated with lower-priority user activity, such as voice calls or SMS. In a further configuration, the length of the timer is set to a specified fixed value for all user activity.

If the user activity 507 for the issuing SIM 130 has not completed, the SIM memory reset management module 330 requeues the UE-generated refresh command 505 and continues to monitor the completion status of the user activity 507. If the user activity 507 for the issuing SIM 130 has completed, the method 500 proceeds to block 512, and the SIM memory reset management module 330 UE processes the generated refresh command 505 and performs a SIM update process or instructs one or more components of the UE device 102 to perform a SIM update process. As described above, if the UE device 102 is operating in an MEP mode, the SIM memory reset management module 330, at block 514, determines if there is another target SIM 130. If there are no other target SIMs 130 to receive the SIM platform reset command 501, the SIM memory reset process is complete at block 516. If there is another target SIM 130, the method 500 returns to block 504 and the SIM memory reset management module 330 sends the SIM memory reset request 501 to the next target SIM 130. The SIM memory reset management module 330 receives a second SIM platform reset command 503 from the second SIM 130-2 and the SIM memory reset management module 330 generates a second refresh command 505. The method 500 proceeds as described above.

As such, the techniques described herein advantageously manage SIM memory reset events when user activity associated with one or more SIMs 130 is occurring at the UE device 102. For example, when the UE device 102 is operating in an MEP mode, a SIM memory reset request is forwarded to each enabled SIM 130 instead of forwarding the request only to the SIM 130 in the first logical position of the communication stack. Also, after a SIM 130 completes a SIM memory reset and issues a SIM update command to the UE device 102, the UE device 102 queues the SIM update command (or the UE-generated refresh command) instead of immediately processing or rejecting the command. By queuing the SIM refresh command (or the UE-generated refresh command), the UE device 102 provides an opportunity for the user activity to complete before processing or rejecting the SIM update command or performing the UE-generated refresh command, which helps prevent the user activity from being dropped and avoid failure of the UE device to update its corresponding SIM information. Also, the UE device 102 is configured to perform different SIM memory reset handling techniques depending on the version(s) of the standard specifications directed to SIM memory resets that is supported by the SIM 130. As such, the UE device 102 is configured such that SIM memory resets are properly handled regardless of the standard specifications supported by the SIM 130.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method at a user equipment (UE) device for managing subscriber identity module (SIM) memory reset events, the method comprising:
responsive to sending a SIM memory reset request to a first SIM, receiving a first SIM update command from the first SIM for a SIM memory reset event;
responsive to receiving the first SIM update command, generating a first refresh command for updating information associated with the first SIM; and
responsive to detecting current user activity associated with the first SIM, queuing the generated first refresh command until one or more conditions are satisfied.

2. The method of claim 1, wherein the SIM update command is a SIM platform reset command.

3. The method of claim 1, further comprising:
responsive to satisfying the one or more conditions, processing the generated first refresh command.

4. The method of claim 1, further comprising:
responsive to detecting no current user activity associated with the first SIM, processing, without queueing, the generated first refresh command.

5. The method of claim 1, further comprising:
responsive to determining that a second SIM is enabled, sending the SIM memory reset request to the second SIM.

6. The method of claim 5, further comprising:
responsive to sending the SIM memory reset request to the second SIM, receiving a second SIM update command from the second SIM;
responsive to receiving the second SIM update command, generating a second refresh command for updating information associated with the second SIM; and
responsive to detecting current user activity associated with the second SIM, queuing the generated second refresh command until one or more conditions are satisfied.

7. The method of claim 6, further comprising:
responsive to satisfying the one or more conditions, processing the generated second refresh command.

8. The method of any one of claim 6, further comprising:
responsive to detecting no current user activity associated with the second SIM, processing, without queueing, the generated second refresh command.

9. A method at a cellular user equipment (UE) device for managing subscriber identity module (SIM) memory reset events, the method comprising:
responsive to sending a SIM memory reset request to a first SIM, receiving a first SIM update command from the first SIM for a SIM memory reset event; and
responsive to detecting current user activity associated with the first SIM, one of queuing the first SIM update command until one or more conditions are satisfied or rejecting the first SIM update command.

10. The method of claim 9, wherein the first SIM update command is a SIM refresh command.

11. The method of claim 9, further comprising:
responsive to the queuing the current user activity, initiating a timer;
responsive to initiating the timer, determining whether the one or more conditions have been satisfied; and
responsive to satisfying the one or more conditions, processing the first SIM update command.

12. The method of claim 11, wherein at least one of the one or more conditions is the current user activity completing prior to the timer expiring.

13. The method of claim 9, further comprising:
responsive to queueing the current user activity, initiating a timer;
responsive to initiating the timer, determining whether at least one condition of the one or more conditions has been satisfied; and
responsive to satisfying at least one condition of the one or more conditions, rejecting the first SIM update command.

14. The method of claim 9, further comprising:
responsive to detecting no current user activity associated with the first SIM, processing, without queueing, the first SIM update command.

15. The method of claim 9, further comprising:
responsive to rejecting the first SIM update command, waiting for the first SIM to reissue the first SIM update command.

16. The method of claim 9, further comprising:
responsive to determining that a second SIM is enabled, sending the SIM memory reset request to the second SIM.

17. The method of claim 16, further comprising:
responsive to sending the SIM memory reset request to the second SIM, receiving a second SIM update command from the second SIM; and
responsive to detecting current user activity associated with the second SIM, queuing the second SIM update command until one or more conditions are satisfied.

18. The method of claim 17, further comprising:
responsive to satisfying the one or more conditions, processing the second SIM update command.

19. A user equipment device configured to implement the method of claim 1.

20. A non-transitory computer-readable medium storing executable instructions configured to manipulate a processor of a user equipment device to implement the method of claim 1.
